(19) United States
(12) Patent Application Publication
(10) Pub. No.: US 2022/0205142 A1
(43) Pub. Date: Jun. 30, 2022

(54) POLYMER, FIBER AND TEXTILE

(71) Applicant: INDUSTRIAL TECHNOLOGY RESEARCH INSTITUTE, Hsinchu (TW)

(72) Inventors: Che-Tseng LIN, Hsinchu City (TW); Zu-Chiang GU, Kaohsiung City (TW); Jen-Chun CHIU, Zhubei City (TW); Pei-Yin CHEN, Taipei City (TW)

(73) Assignee: INDUSTRIAL TECHNOLOGY RESEARCH INSTITUTE, Hsinchu (TW)

(21) Appl. No.: 17/406,581

(22) Filed: Aug. 19, 2021

(30) Foreign Application Priority Data
Dec. 25, 2020 (TW) 109146341

(51) Int. Cl. D01F 6/66; C08G 69/40

(52) U.S. Cl. CPC D01F 6/66; C08G 69/40; D10B 2501/04; D10B 2401/02; D10B 2401/14; D10B 2331/06

(57) ABSTRACT

A polymer includes a repeating unit M and a repeating unit D, the repeating unit M is —COC₆H₆CONHCH₂CH₂O—, the repeating unit D is —COC₆H₆COOCH₂CH₂O—, and a molar ratio of the repeating unit M to the repeating unit D is 1:6 to 1:999.

This application claims the benefit of Taiwan application Serial No. 109146341, filed Dec. 25, 2020, the invention of which is incorporated by reference herein in its entirety.

### TECHNICAL FIELD

The invention relates in general to a polymer, a fiber and a textile.

### BACKGROUND

Polyester fibers, such as polyethylene terephthalate (PET), are currently one of the most widely used man-made fibers, which have excellent mechanical strength, elasticity, dimensional stability, abrasion resistance and wrinkle resistance, and had been widely used in clothing. However, it is a hydrophobic material in nature. When it is used as a fiber for clothing materials, such as underwear or sportswear that directly contact with the skin, the sweat on the user's skin is not easily absorbed by the clothing that is worn in a hot and humid environment, so as to make the user feeling stuffy and sticky. In this case, its overall comfort is worse than that of natural fibers.

In order to improve wearing comfort, making functional textiles that can absorb moisture and wick sweat have become the goal of various textile manufacturers. Improving hydrophilic and hygroscopicity of the functional textiles not only increases its wearing comfort, but also has a positive effect on its dyeability, decontamination and reduction of static electricity generation.

### SUMMARY

The present disclosure relates to a polymer, a fiber and a textile, which have improved moisture absorbing and releasing properties and maintain excellent color fastness.

According to one aspect of the present disclosure, a polymer is provided, wherein the polymer includes a repeating unit M and a repeating unit D, the repeating unit M is —COC₆H₆CONHCH₂CH₂O—, the repeating unit D is —COC₆H₆COOCH₂CH₂O—, and a molar ratio of the repeating unit M to the repeating unit D is 1:6 to 1:999.

According to another aspect of the present disclosure, a fiber is provided, wherein the fiber is made of the above-mentioned polymer.

According to yet another aspect of the present disclosure, a textile is provided, wherein the textile is made of the above-mentioned fibers.

The above objects and advantages of the present disclosure will become more readily apparent to those ordinarily skilled in the art after reviewing the following detailed description and accompanying drawings, in which:

### BRIEF DESCRIPTION OF THE DRAWINGS

FIG. 1 is a curve diagram illustrating the viscosity-shear rate-relationships of polyesters in the embodiments and the comparative embodiments of the present disclosure.

### DETAILED DESCRIPTION

According to the embodiments of the present disclosure, a polymer, a fiber made of the polymer, and a textile made of the fibers, which have excellent moisture absorbing and releasing properties, are provided.

In one embodiment, the polymer includes a repeating unit M and a repeating unit D.

The repeating unit M is —COC₆H₆CONHCH₂CH₂O—. In one embodiment, it has a structure, for example, as shown in the following Formula (I), but it is not limited thereto. In other embodiments, the substituents on the benzene ring are located at either ortho positions or meta positions.

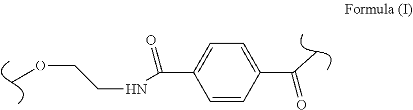

The repeating unit D is —COC₆H₆COOCH₂CH₂O—. In one embodiment, it has a structure, for example, as shown in the following Formula (II), but it is not limited thereto. In other embodiments, the substituents on the benzene ring are located at either ortho positions or meta positions.

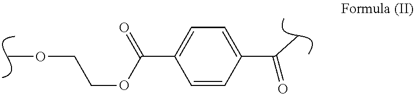

In the present embodiment, the polymer has a —NH— structure that can generate hydrogen bonding force with external water molecules, so it has better hydrophilic and hygroscopic properties. Using the polymer to make fibers or textiles (such as cloth) may increase its moisture wicking properties.

In the present embodiment, a molar ratio (i.e., the mole number m of the repeating unit M:the mole number d of the repeating unit D) of the repeating unit M to the repeating unit D is 1:6 to 1:999, by which the polymer has characteristics of strapping and winding, and has excellent moisture absorbing and releasing properties. The polymer can have processability and the textile made of thereof can have wearing comfort. If the ratio of m:d is too small, the polyester may not be able to strap and wind smoothly. In some embodiments, the mole number m of the repeating unit M: the mole number d of the repeating unit D can be, for example, 1:6 to 1:500, 1:7 to 1:999, 1:7 to 1:500, 1:6 to 1:400 or 1:7 to 1:400.

In the present embodiment, the mole number m of the repeating unit M can range from 0.001 to 0.4. In some embodiments, the mole number m of the repeating unit M can range from 0.005 to 0.4, from 0.007 to 0.4, from 0.005 to 0.35, from 0.007 to 0.35, or from 0.009 to 0.3.

In the present embodiment, the mole number d of the repeating unit D can range from 2.6 to 4. In some embodiments, the mole number d of the repeating unit D can range from 2.6 to 3.5, from 2.65 to 4, from 2.65 to 3.5, or from 2.7 to 3.

In the present embodiment, the polymer may have an intrinsic viscosity ranging from 0.4 dl/g to 1.2 dl/g. In some embodiments, the intrinsic viscosity of the polymer may range from 0.6 dl/g to 0.7 dl/g.

In the present embodiment, the method for producing the polymer may include steps of performing a polymerization (esterification reaction) by mixing terephthalic acid (PTA), ethanolamine (ETA), and ethylene glycol (EG) to obtain the polymer. In the present embodiment, ethylene glycol may be an excess reactant, and ethanolamine and terephthalic acid may be almost completely consumed by the reaction, but the present disclosure is not limited to this regard. For example, The molar ratio of terephthalic acid:ethanolamine:ethylene glycol can be 1:0.01 to 0.14:0.86 to 0.99. In the present embodiment, m:d may be the mole number of ethanolamine: the result of the mole number of terephthalic acid minus the mole number of ethanolamine. In the present embodiment, the mixture may further include a catalyst, such as tetrabutyl titanate, antimony acetate, zinc acetate, cobalt acetate, manganese acetate, sodium acetate, potassium acetate, magnesium acetate, calcium acetate, and the like.

The polymerization may include heating the mixture. The heating temperature can range from 120° C. to 300° C. In the present embodiment, the heating may be a multistage heating, for example, the mixture can be heated at a first heating temperature during a first heating period, and then the mixture is heated at a second heating temperature during a second heating period. The first heating temperature may range, for example, from 240° C. to 270° C. The first heating period may last, for example, for 2 hours to 4 hours. The second heating temperature may be higher than the first heating temperature. The second heating temperature may range, for example, from 271° C. to 290° C. The second heating period may last, for example, for 0.5 hour to 3 hours.

The above objects and advantages of the present disclosure will become more readily apparent to those ordinarily skilled in the art after reviewing the following embodiments, in which:

### Embodiment 1

Terephthalic acid (PTA) (498 g, 3.00 mole), ethylene glycol (242 g, 3.89 mole, excess reactant), ethanolamine (ETA) (1.83 g, 0.03 mole) and 100 ppm of catalyst tetrabutyl titanate were added into a reaction tank to form a mixture, and the mixture was heated to 260° C. to performed a polymerization under a reaction pressure of 3 Kg for 3 hours (the first heating period). Subsequently, 400 ppm of catalyst tetrabutyl titanate and 100 ppm of antioxidant CHEMNOX-168 (purchased from Dunhou Co., Ltd.) were added, and the mixture was heat to 280° C. under vacuum for performing the polymerization for 60 minutes (the second heating period) to form the polymer. The polymer had a chemical structure including the repeating unit M (i.e. —COC₆H₆CONHCH₂CH₂O—) and the repeating unit D (i.e. —COC₆H₆COOCH₂CH₂O—).

1H NMR (400 MHz, ppm, CDCl₃): 8.20-8.17 (phenyl, 8H, d), 7.90 (—NH, 1H, s), 4.86 (—CH₂—, 6H, s), 3.86 (—CH₂—, 2H, s).

### Embodiment 2

The method for preparing the polymer of the present embodiment was similar to that of embodiment 1, except that the amount of ethanolamine used was 5.49 g (0.09 mole), and the second heating period for which the mixture was heated was 100 minutes. The polymer had a chemical structure including the repeating unit M and the repeating unit D.

### Embodiment 3

The method for preparing the polymer of the present embodiment was similar to that of embodiment 2, except that the amount of ethanolamine used was 9.15 g (0.15 mole). The polymer had a chemical structure including the repeating unit M and the repeating unit D.

### Embodiment 4

The method for preparing the polymer of the present embodiment was similar to that of embodiment 2, except that the amount of ethanolamine used was 12.8 g (0.21 mole). The polymer had a chemical structure including the repeating unit M and the repeating unit D.

### Embodiment 5

The method for preparing the polymer of the present embodiment was similar to that of embodiment 1, except that the amount of ethanolamine used was 18.3 g (0.30 mole), and the second heating period for which the mixture was heated was 120 minutes. The polymer had a chemical structure including the repeating unit M and the repeating unit D.

### Embodiment 6

The method for preparing the polymer of the present embodiment was similar to that of embodiment 1, except that the amount of ethanolamine used was 0.009 mole. The polymer had a chemical structure including the repeating unit M and the repeating unit D.

### Embodiment 7

The method for preparing the polymer of the present embodiment was similar to that of embodiment 1, except that the amount of ethanolamine used was 0.018 mole, and the second heating period for which the mixture was heated was 90 minutes. The polymer had a chemical structure including the repeating unit M and the repeating unit D.

### Comparative Embodiment 1

Terephthalic acid (PTA) (498 g, 3.00 mole), ethylene glycol (242 g, 3.89 mole), 400 ppm of catalyst antimony acetate, 200 ppm of antioxidant CHEMNOX-1010 (purchased from Dunhou Co., Ltd.) and 100 ppm of antioxidant CHEMNOX-168 were added into a reaction tank to form a mixture, and the mixture was heated to 260° C. under a reaction pressure of 3 Kg for 3 hours. Then, sorbitol (5.45 g, 0.03 mole) was added under normal pressure, and after reacting at 260° C. for 1 hour, the temperature was heated to 280° C., and the mixture was under vacuum to perform a polymerization for 100 minutes to form a polymer.

### Comparative Embodiment 2

Terephthalic acid (PTA) (498 g, 3.00 mole), ethylene glycol (242 g, 3.89 mole), 250 ppm of catalyst antimony acetate, 200 ppm of the catalyst zinc acetate, 200 ppm of antioxidant CHEMNOX-1010 and 100 ppm of antioxidant CHEMNOX-168 were added into a reaction tank to form a mixture, and the mixture was heated to 260° C. under a reaction pressure of 3 Kg for 3 hours. Then, after polyethylene glycol (PEG2000) with a weight average molecular weight of 2000 (60 g, 0.03 mole) and 350 ppm of the catalyst tetrabutyl titanate were added, the mixture was under vacuum and a polymerization was carried out at 260° C. for 100 minutes to form a polymer.

### Comparative Embodiment 3

An unmodified polyethylene terephthalate (PET), a commercial material of textile fiber grade ester pellets purchased from CHUNG SHING TEXTILE CO., LTD, was provided.

### Comparative Embodiment 4

Terephthalic acid (PTA) (498 g, 3.00 mole), ethylene glycol (242 g, 3.89 mole), ethanolamine (27.43 g, 0.45 mole) and 100 ppm of catalyst tetrabutyl titanate were added into a reaction tank to form a mixture, and the mixture was heated to 260° C. under a reaction pressure of 3 Kg for 3 hours. Then, after 400 ppm of catalyst tetrabutyl titanate and 100 ppm of antioxidant CHEMNOX-168 were added, the mixture was heat to 280° C. under vacuum to perform a polymerization for 120 minutes. After the completion of the reaction, the material obtained was a telephone wire-like coiled hard solid. In the end, since it was unable to strap and wind, thus cannot subject further evaluation tests.

Table 1 lists the mole number of the terephthalic acid (PTA) monomer, the mole number of the ETA monomer (i.e., the mole number m of the repeating unit M of the polymer), the result of the mole number of the monomer PTA minus the mole number of the monomer ETA (i.e., the mole number d of the repeating unit D of the polymer), the ratio of the mole number m of the repeating unit M of the polymer to the mole number d of the repeating unit D of the polymer (i.e., m:d), and the molar ratio of the monomer PTA to the monomer ETA, of Embodiments 1 to 7 and Comparative Embodiments 4.

TABLE 1

| | PTA | | | | |
|---|---|---|---|---|---|
| | (mole) | m (mole) | d (mole) | m:d | PTA:ETA |
| Embodiment 1 | 3 | 0.03 | 2.97 | 1:99 | 1:0.01 |
| Embodiment 2 | 3 | 0.09 | 2.91 | 1:32.3 | 1:0.03 |
| Embodiment 3 | 3 | 0.15 | 2.85 | 1:19 | 1:0.05 |
| Embodiment 4 | 3 | 0.21 | 2.79 | 1:13.3 | 1:0.07 |
| Embodiment 5 | 3 | 0.3 | 2.7 | 1:9 | 1:0.1 |
| Embodiment 6 | 3 | 0.009 | 2.991 | 1:332 | 1:0.003 |
| Embodiment 7 | 3 | 0.018 | 2.982 | 1:166 | 1:0.006 |
| Comparative | 3 | 0.45 | 2.55 | 1:5.7 | 1:0.15 |
| Embodiment 4 | | | | | |

As shown in Table 1, in the embodiments of the present disclosure, when the mole number of the monomer ETA: the result of the mole number of the monomer PTA minus the mole number of the monomer ETA (i.e., m:d) was 1:6 to 1:999, the polymer had the characteristics of strapping and winding suitable for the textile industry. According to the comparative embodiment 4, when the mole number of monomer ETA: the result of the mole number of the monomer PTA minus the mole number of the monomer ETA (i.e., m:d) was greater than ⅙, the polyester was unable to strap and wind. It had poor processability and was difficult to apply to the textile industry.

### Comparative Embodiment 5

Terephthalic acid (PTA) (498 g, 3.00 mole), ethylene glycol (242 g, 3.89 mole), xylitol (23 g, 0.15 mol), 200 ppm of antioxidant CHEMNOX-1010 and 100 ppm of antioxidant CHEMNOX-168 were added into a reaction tank to form a mixture, and the mixture was heated to 260° C. under a reaction pressure of 3 Kg for 3 hours. Then, after 400 ppm of catalyst antimony acetate was added, the mixture was heat to 280° C. under vacuum to perform a polymerization for 45 minutes. The final polymer was a lump of hard solid.

### Comparative Embodiment 6

The method for preparing the polymer of the comparative embodiment 6 was similar to that of comparative embodiment 5, except that the xylitol used in the process for forming the polymer of the comparative embodiment 5 was replaced by sorbitol (23 g, 0.15 mole). The final polymer was a lump of hard solid.

<Evaluation>

[Contact Angle]

The optical contact angle of static water disposed on the polymer sample (0.1 mm film) was measured by the sessile drop method. The measuring liquid was distilled water. During the test, water drops were disposed on the surface of the polymer membrane and wait for 5 minutes to obtain the static water contact angle of the sample.

The criteria for evaluating the texture of the sample was based on the contact angle of 90°, if it exceeded 90°, the sample tested can be considered as having hydrophobic properties, and if the contact angle was less than 90°, the sample tested can be considered as having hydrophilic properties. The smaller the contact angle, the better the hydrophilic and hygroscopic properties of the sample.

[Moisture Absorption and Desorption Parameters (AMR)]

The polymer sample was dried with hot air at a temperature of 60° C. for 30 minutes. Next, the sample was dried with hot air at a temperature of 105° C. for 2 hours, and the mass (Wd) was measured. The measured quality can be referred as “absolute dry quality”.

The sample was placed in a constant temperature and humidity chamber that had been humidified at 20° C.×65% RH for 24 hours; the mass (W20) of the sample was measured when it was in equilibrium, and the setting of the constant temperature and humidity chamber was then changed to 30° C.×90% RH, the mass (W30) of the sample was then measured after a further standing of 24 hours. The ΔMR can be calculated according to the following mathematical formula. The larger the ΔMR value, the better the moisture absorption and desorption properties, and the better the wearing comfort of the textile.

Moisture absorption and desorption parameters (ΔMR)=(W30−W20)/Wd(%)

[Melting Point (Tm)]

The Tm was measured according to ASTM D3418 standard.

[Glass transition temperature (Tg)]

The Tg was measured according to ASTM D3418 standard

The higher the Tg, the better the color fastness of the fiber or textile made of the polymer after dyeing. The lower the Tg, the worse the color fastness of the fiber or textile made of the polymer after dyeing.

[Intrinsic Viscosity (IV)]

A co-solvent (in which a volume ratio of phenol to tetrachloroethane was 6:4) was used to prepare a solution with a concentration of 0.3 g/dL. The viscosity was calculated from the measurements done with an Ostwald Viscometer in a constant temperature water tank at 30° C.

Table 2 lists the contact angles, the moisture absorbing and releasing parameters (ΔMR), the melting points (Tm), the glass transition temperatures (Tg) and the intrinsic viscosities (IV) of Embodiments 1 to 7 of the present disclosure and the comparative Embodiments 1 to 3.

TABLE 2

| | Contact | | | | |
|---|---|---|---|---|---|
| | angle | ΔMR(%) | Tm(° C.) | Tg(° C.) | IV(dl/g) |
| Embodiment 1 | 77 | 0.19 | 248.7 | 81.1 | 0.69 |
| Embodiment 2 | 75 | 0.20 | 245.6 | 80.1 | 0.7 |
| Embodiment 3 | 74 | 0.22 | 246.7 | 80.2 | 0.7 |
| Embodiment 4 | 69 | 0.22 | 245.5 | 81.6 | 0.68 |
| Embodiment 5 | 70 | 0.24 | 237.2 | 79.7 | 0.67 |
| Embodiment 6 | 78 | 0.19 | 248.5 | 80.1 | 0.69 |
| Embodiment 7 | 78 | 0.21 | 249.4 | 80.9 | 0.67 |
| Comparative | 80 | 0.23 | 235.3 | 76.0 | 0.67 |
| Embodiment 1 | | | | | |
| Comparative | 70 | 0.31 | 240.9 | 62.4 | 0.76 |
| Embodiment 2 | | | | | |
| Comparative | 101 | 0.10 | 252.1 | 80.6 | 0.63 |
| Embodiment 3 | | | | | |

It can be found from Table 2 that the contact angles of the polymers provided by Embodiments 1 to 7 were smaller than that of the comparative embodiment 3, and the ΔMR of the polymers provided by Embodiments 1 to 7 were greater than that of the comparative embodiment 3. That means that the polymers provided by Embodiments 1 to 7 had better moisture absorbing and releasing properties, and the fiber made from the polymers or the textile made from the fibers can have better wearing comfort.

The glass transition temperatures (Tg) of the polymers provided by Embodiments 1 to 7 were higher than that of the comparative embodiments 1 and 2 which can indicate that the polymers provided by Embodiments 1 to 7 had better color fastness properties after dyeing. The glass transition temperatures of the polymers provided by Embodiments 1 to 7 were similar to that of the comparative embodiment 3, which can indicate that the fibers made from the polymers of Embodiments 1 to 7 or the textiles made of such fibers may had the same color fastness properties after dyeing as that of the current commercially available PET products.

[Rheological Properties]

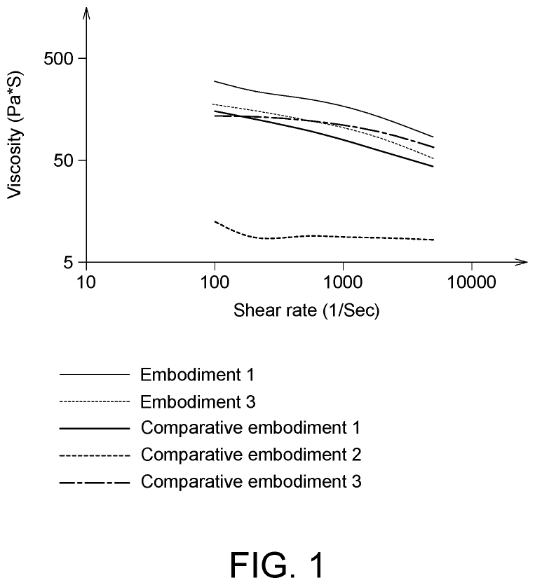

The melt viscosity of the polymer sample can be evaluated through a capillary rheometer. The shear rate ranges used for the evaluation were: 100 (1/s), 200 (1/s), 500 (1/s), 1000 (1/s), 2000 (1/s), 5000 (1/s). The processing temperature was 275° C. The retention time was 10 minutes. The results were shown in FIG. 1, which illustrated rheological characteristic curves of viscosity and shear rate. It can be found that the melt viscosity distribution of the polymers provided by the embodiments of the present disclosure was closer to that of the comparative embodiment 3 (which was the currently commercially available PET product), in comparison with the comparative embodiment 1 and 2. It can be indicated that the processing properties (such as the melt flow properties of the extrusion spinning nozzle) of the polymers provided by the embodiments of the present disclosure were more similar to the currently commercially available PET product. Therefore, the polymers provided by the embodiments of the present disclosure had good processing compatibility, because they can be treated by using commonly used fibers manufacturing process, equipment and parameters.

It will be apparent to those skilled in the art that various modifications and variations can be made to the disclosed embodiments. It is intended that the specification and examples be considered as exemplary only, with a true scope of the invention being indicated by the following claims and their equivalents.

What is claimed is:

1. A polymer, comprising:
a repeating unit M; and
a repeating unit D,
wherein the repeating unit M is —COC₆H₆CONHCH₂CH₂O—, the repeating unit D is —COC₆H₆COOCH₂CH₂O—, and a molar ratio of the repeating unit M to the repeating unit D is 1:6 to 1:999.

2. The polymer according to claim 1, wherein the repeating unit M has a structure shown in Formula (I) as follows:

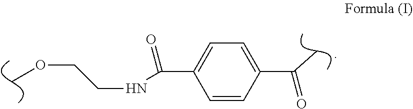

3. The polymer according to claim 1, wherein the repeating unit D has a structure shown in Formula (II) as follows:

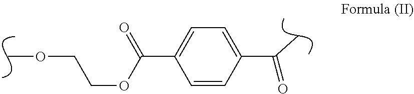

4. The polymer according to claim 1, wherein a molar ratio of the repeating unit M to the repeating unit D is 1:7 to 1:999.

5. The polymer according to claim 1, wherein a molar ratio of the repeating unit M to the repeating unit D is 1:6 to 1:500.

6. The polymer according to claim 1, wherein the polymer has an intrinsic viscosity ranging from 0.4 dl/g to 1.2 dl/g.

7. A fiber made of a polymer, wherein the polymer comprises:
a repeating unit M; and
a repeating unit D,
wherein the repeating unit M is —COC₆H₆CONHCH₂CH₂O—, the repeating unit D is —COC₆H₆COOCH₂CH₂O—, and a molar ratio of the repeating unit M to the repeating unit D is 1:6 to 1:999.

8. The fiber according to claim 7, wherein the repeating unit M has a structure shown in Formula (I) as follows:

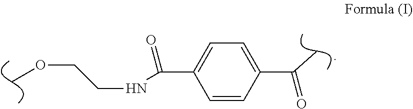

9. The fiber according to claim 7, wherein the repeating unit D has a structure shown in Formula (II) as follows:

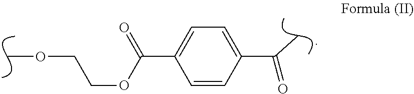

10. The fiber according to claim 7, wherein a molar ratio of the repeating unit M to the repeating unit D is 1:7 to 1:999.

11. The fiber according to claim 7, wherein a molar ratio of the repeating unit M to the repeating unit D is 1:6 to 1:500.

12. The fiber according to claim 7, wherein the polymer has an intrinsic viscosity ranging from 0.4 dl/g to 1.2 dl/g.

13. A textile made of a fiber, wherein the fiber is made of a polymer, and the polymer comprises:
a repeating unit M; and
a repeating unit D,
wherein the repeating unit M is —COC₆H₆CONHCH₂CH₂O—, the repeating unit D is —COC₆H₆COOCH₂CH₂O—, and a molar ratio of the repeating unit M to the repeating unit D is 1:6 to 1:999.

14. The textile according to claim 13, wherein the repeating unit M has a structure shown in Formula (I) as follows:

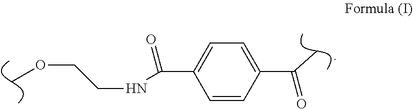

15. The textile according to claim 13, wherein the repeating unit D has a structure shown in Formula (II) as follows:

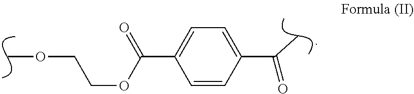

16. The textile according to claim 13, wherein a molar ratio of the repeating unit M to the repeating unit D is 1:7 to 1:999.

17. The textile according to claim 13, wherein a molar ratio of the repeating unit M to the repeating unit D is 1:6 to 1:500.

18. The textile according to claim 13, wherein the polymer has an intrinsic viscosity ranging from 0.4 dl/g to 1.2 dl/g.
